(19) United States
(12) Patent Application Publication
(10) Pub. No.: US 2005/0223050 A1
(43) Pub. Date: Oct. 6, 2005

(54) Efficient method and apparatus for convolution of input signals

(76) Inventors: Chi-Min Liu, Hsinchu City (TW); Win-Chieh Lee, Taoyuan City (TW); Chung-Han Yang, Chiayi Hsien (TW)

Correspondence Address: SUPREME PATENT SERVICES, POST OFFICE BOX 2339, SARATOGA, CA, 95070, US

(21) Appl. No.: 10/817,352

(22) Filed: Apr. 1, 2004

(51) Int. Cl. G06F 17/10

(52) U.S. Cl. 708/420

(57) ABSTRACT

An FIR-based apparatus performs fast convolution in the frequency domain for generating room reverberation. The impulse response of a room is segmented and transformed by FFT to form a plurality of segmented room frequency spectra. The input signal to the room is also segmented and transformed to form segmented input frequency spectra. Either overlap-and-add method or overlap-and-save method is applied in the apparatus to accomplish the fast convolution based on the multiplication of segmented input frequency spectrum and segmented room frequency spectrum. To further reduce the complexity of the convolution, a segmented room frequency spectrum is processed to remove high frequency components before being used in the fast convolution according to a perceptual criterion.

### FIELD OF THE INVENTION

The present invention generally relates to the convolution of input signals, and more specifically to the implementation of artificial reverberation using Fast Fourier Transform (FFT) convolution methods.

### BACKGROUND OF THE INVENTION

Reverberation is the result of a complicated echo system. A listener in a room hears not only the direct signal from the source, but also other reflected sounds from the walls, floor or some other objects in the room. As shown in FIG. 1, the signal heard by the listener is a summation of all reflected signals.

The effect of reverberation is a multiplicity of temporally close echoes that are not perceptually separate from one another. FIG. 2 shows the impulse response of the Foellinger Great Hall. From FIG. 2, it can be seen that the peaks for later part of the impulse response are very close, and only few peaks in the earlier part clearly stand out of the response. Based on this characteristic, the reverberation can be separated into two parts. As shown in FIG. 3, those peaks in earlier part are called earlier reflections, and the later part is called late reverberation.

Artificial reverberators have been used to add reverberation to studio recording in the music and film industry, or to modify the acoustic effect of a listening room. There have been basically two approaches to designing reverberators. The first approach is based on the IIR (Infinite Impulse Response)-recursive networks such as comb filters and all-pass filters, and the second approach is based on FIR (Finite Impulse Response) networks. The IIR-based network has the merit in low complexity, but is often difficult to eliminate unnatural resonance. On the other hand, the FIR-based reverberators, which convolve the input sequence with an impulse response modeling the environment such as a concert hall, are free from the unnatural resonance. However, the high computational complexity due to the long FIR length leads to another concern in real-time applications. For two seconds of impulse response, the length is 88,200 samples in terms of 44,100 Hz sampling rate. Using direct convolution to implement the reverberation requires 88,200 multiplications for each sample, or 7.8 G multiplications per second for stereo audio.

The IIR-based approach suitably combines various filter modules such as comb filters, all-pass filters, and low-pass filters to simulate the reverberation effect. Due to the nature of the recursive filters, the complexity is in general lower than the FIR-based approach. However, its quality depends on some detail calibration and it is also difficult to model the existing environment directly.

The FIR-based approach records the environment response, such as a concert hall or a church, as the impulse response and then applies the direct convolution to have the reverberation effect. The environment response can be recorded from real environment using a loud speaker and microphones. FIG. 2 is an example of environment response. The length of a natural environment response may be varying from 1 to several seconds depending on the size of the room, the material of the walls and other surfaces in the room.

The direct convolution between input signal x[n] and impulse response h[n] of length L is expressed as

$$y [ n ] = x [ n ] * h [ n ] = {\sum }_{k = 0}^{L - 1} x [ n - k ] h [ k ] \qquad ( 1 )$$

The implementation of (1) is shown in FIG. 4 and its direct implementation leads to L multiplications per output sample, which is too complicated for reverberation. As mentioned above, by direct convolution, convolving a stereo input signal with impulse response requires 7.8 G multiplications per second. This is almost impossible for processors today.

In addition to the direct convolution methods in the time domain, the FIR-based approach can also be implemented by FFT convolution methods in the frequency domain. By means of fast computation accomplished by FFT, the FFT convolution methods significantly speed up the FIR-based approach.

There have been some researches trying to reduce the complexity of the FIR-based approach by modifying the impulse response according to perceptual criteria. For example, a perceptual convolution method has been proposed to reduce the number of taps in FIR filters to create reverberation without coloration. This approach tries to change the impulse response in time-domain to reduce the multiplications needed for convolution method. However, the approach can only be applied to direct convolution methods. Therefore, its complexity is still higher than FFT convolution methods.

### SUMMARY OF THE INVENTION

This invention has been made to reduce the complexity of implementing artificial room reverberation using FIR-based approaches. A primary object of the invention is to provide an efficient method for the convolution of input signals. It is also an object of the invention to provide an apparatus and method to reduce the complexity of the reverberators using FFT-based methods and the segmented impulse response of the room environment. Another object is to further reduce the complexity using fast perceptual convolution by truncating the high frequency parts of the segmented impulse response based on perceptual thresholds.

Accordingly, by extending both overlap-and-add and overlap-and-save methods of block convolution to segmented impulse response of the room environment, fast convolution methods based on FFT are used to speed up the FIR-based approaches in generating artificial reverberation. The present invention first segments an environment impulse response, computes its segmented response frequency spectrum by FFT. The input signal is also segmented and FFT transformed to obtain segmented input frequency samples.

In one embodiment of the overlap-and-add method, the segmented input frequency samples are multiplied by the frequency samples of each segment of the impulse response. The multiplication output of each segment is inversely transformed by IFFT respectively. The outputs of the IFFT from all the segments are then overlapped and added together to generate the final reverberation signal.

In an alternative embodiment of the overlap-and-add method of this invention, the segmented input frequency samples are buffered segment by segment and then multiplied by the frequency samples of each segment of the impulse response. The multiplication outputs from all the buffered segments are then summed together. The summation output is inversely transformed by IFFT. The output of the IFFT is then overlapped and added together generate the final reverberation signal.

In another embodiment of this invention, the overlap-and-save method is applied with segmented impulse response. The input signal is first segmented, overlapped and saved. The overlap-and-save input signal is then FFT transformed to obtain the segmented input frequency samples that are buffered segment by segment and then multiplied by the frequency samples of each segment of the impulse response. The multiplication outputs from all the buffered segments are also summed together. The summation output is inversely transformed by IFFT. By discarding the first segment of the output of the IFFT, the final reverberation signal is obtained.

According to this invention, a fast perceptual convolution is provided to reduce the computational complexity required by FIR-based reverberators. The conventional perceptual approach tries to change the impulse response in time domain to reduce the multiplications needed for the convolution method. The fast perceptual convolution of this invention is to reduce the multiplications needed in frequency domain for the FFT convolution methods by applying some threshold to truncate the segmented spectrum.

In the fast perceptual convolution of the present invention, the segmented response frequency spectrum of the impulse response is truncated based on a threshold in quiet which is the threshold characterizing the minimum amount of energy needed in a pure tone detected by human hearing system in a noiseless environment. The high frequency parts of the impulse response that are not perceptible are eliminated. The truncated frequency spectrum of the impulse response can then be applied to various embodiments of the invention to further reduce the computational complexity.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows that a listener in a room hears the signal which is a summation of all reflected signals.

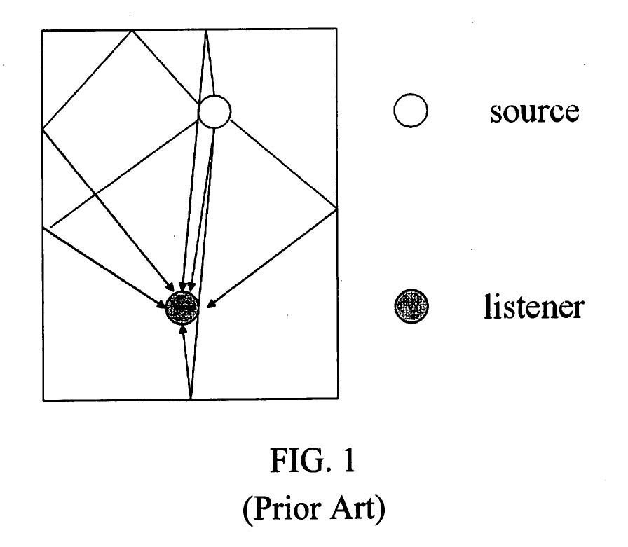

FIG. 2 shows the impulse response of Foellinger Great Hall.

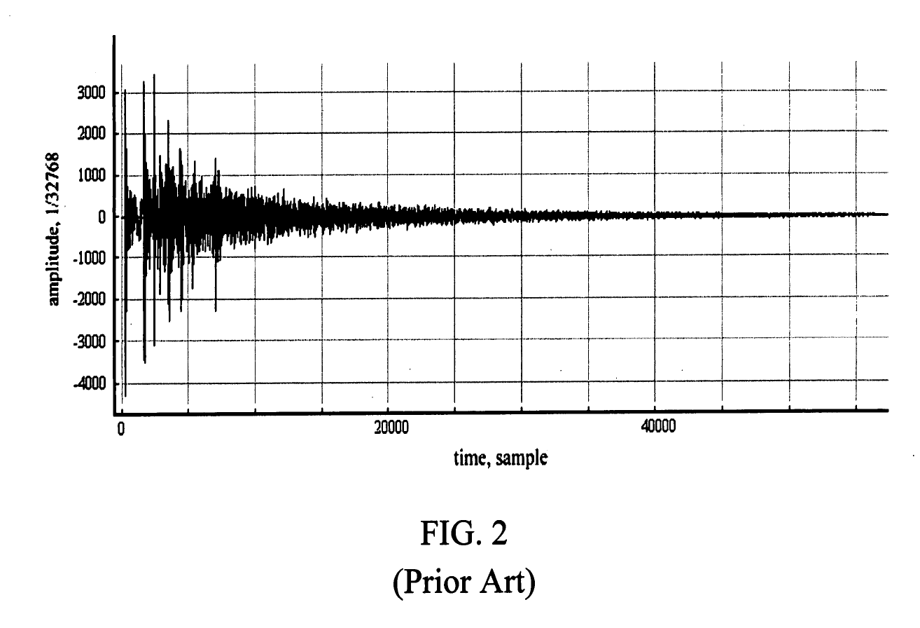

FIG. 3 shows a direct signal, early reflections and late reverberation.

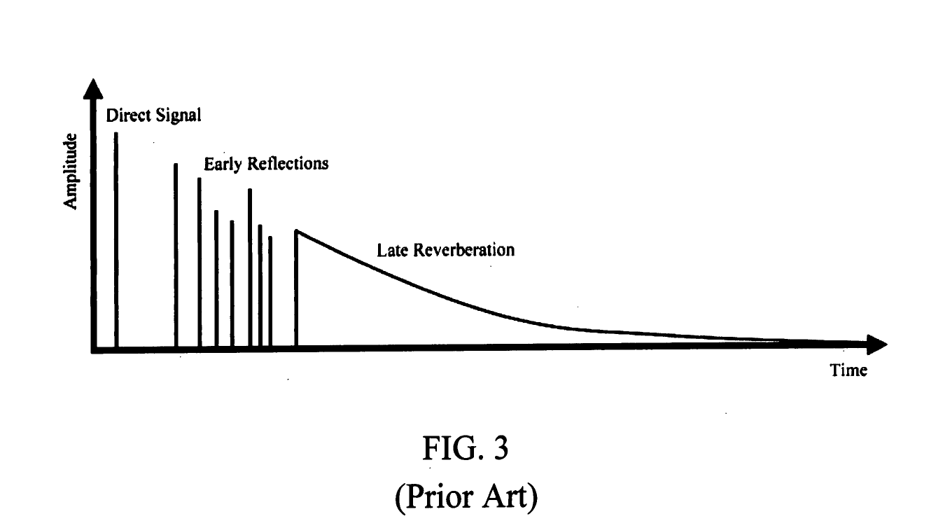

FIG. 4 shows the block diagram of direct convolution for implementing an FIR.

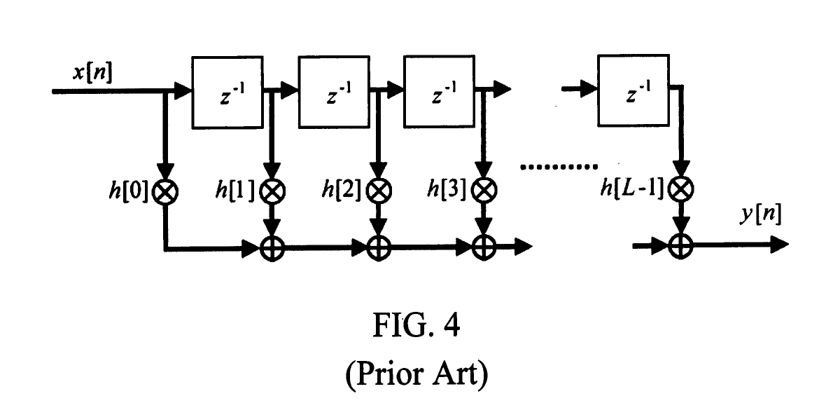

FIG. 5 shows the block diagram of FFT convolution for overlap-and-add method according to Algorithm 1 of the present invention.

FIG. 6 shows the block diagram of FFT convolution for overlap-and-add method according to Algorithm 2 of the present invention.

FIG. 7 illustrates the complexity of Algorithm 1 and Algorithm 2 by means of the number of real multiplications per sample with respect to the block length.

FIG. 8 shows the block diagram of FFT convolution for overlap-and-save method according to Algorithm 1 of the present invention.

FIG. 9 shows the block diagram of zero-delay fast convolution implementation for 88200 (90112) samples of impulse response.

FIG. 10 shows the block diagram of 2-level zero-delay fast convolution implementation of 88200 (90112) samples of impulse response.

FIG. 11 shows the spectrum of the impulse response recorded from St. John Lutheran Church.

FIG. 12 shows the spectrum of the impulse response recorded from St. John Lutheran Church after applying the perceptual threshold according to the present invention.

FIG. 13 shows the block diagram of FFT convolution for overlap-and-add method according to Algorithm 2 of the present invention using fast perceptual convolution.

FIG. 13A shows the block diagram of FFT convolution for overlap-and-add method according to Algorithm 2 of the present invention with the perceptual sparse processing implemented after the FFT of the input signals.

FIG. 14 shows the cutoff frequency point found in each block of four different impulse responses.

FIG. 15 shows the comparison of complexity of fast perceptual convolution and Algorithm 2 when the length of the impulse response is 2 seconds.

FIG. 16 shows that the fast perceptual convolution can reduce about 30% complexity as compared with Algorithm 2 in real applications.

FIG. 17 shows the block diagram of the low-latency implementation using fast perceptual convolution according to the invention.

### DETAILED DESCRIPTION OF THE PREFERRED EMBODIMENTS

In contrast to direct convolution, a much more efficient approach for implementing the FIR-based methods is to compute convolution through block convolution, in which the signal and impulse response are segmented into sections of length N. Convolution of each block convolution is then implemented through the FFT. There have been two approaches to block convolutions. One is overlap-and-add method and the other is overlap-and-save method. In both overlap-and-add and overlap-and-save methods, the convolution of each pair of small blocks can be accomplished by transforming them from time domain to Discrete Fourier Transform (DFT) domain and performing multiplications on DFT domain. Because the complexity of specific sizes of DFT can be reduced from O(N²) to O(NlogN) by FFT algorithms, using these algorithms to perform the convolution can significantly reduce the complexity.

For overlap-and-add method, the convolution is done on each input segment. If the input segment size is N and the impulse response length is L, it will produce N+L−1 samples of output for each segment. The later L−1 samples of each output segment will affect its following output segments. For each small segment xᵣ[n] with length N, the convolution produces the corresponding output segments yᵣ[n] of length N+L−1. Then, those output segments are added to produce the result signal y[n]. This result is equivalent to the result produced by direct convolution.

Because the length of the impulse response for room reverberation can be as high as several seconds, the extension of the segmentation can be applied to the impulse response to have the computation merit. To extend the overlap-and-add approach to segmented impulse response, let the input signals x[n] and impulse response h[n] be segmented as a sum of shifted finite-length segments of length N, i.e.,

$$\begin{matrix}x [ n ] = {\sum }_{r = 0}^{∞} {x}_{r} [ n - rN ] , and & ( 2 ) \\ h [ n ] = {\sum }_{s = 0}^{M - 1} {h}_{s} [ n - sN ] , & ( 3 )\end{matrix}$$

where M is the smallest integer larger than L divided by N, i.e.

$$M = ⌈ \frac{L}{N} ⌉$$

$$\begin{matrix}{x}_{r} [ n ] = \{ \begin{matrix}x [ n + rN ] , & 0 \leq n \leq N - 1 \\ 0 , & otherwise\end{matrix} , and & ( 4 ) \\ {h}_{s} [ n ] = \{ \begin{matrix}h [ n + sN ] , & 0 \leq n \leq N - 1 \\ 0 , & otherwise\end{matrix} & ( 5 )\end{matrix}$$

Substituting (2) and (3) into (1) yields

$$y [ n ] = \{ {\sum }_{r = 0}^{∞} {x}_{r} [ n - rN ] \} * \{ {\sum }_{s = 0}^{M - 1} {h}_{s} [ n - sN ] \} \qquad ( 6 )$$

Because convolution is linear time-invariant, it follows that

$$y [ n ] = {\sum }_{r = 0}^{∞} {\sum }_{s = 0}^{M - 1} {x}_{r} [ n - rN ] * {h}_{s} [ n - sN ] \\ = {\sum }_{r = 0}^{∞} {\sum }_{s = 0}^{M - 1} {y}_{r , s} [ n - rN - sN ] , \qquad ( 7 )$$

where
y_{r,s}[n]=xᵣ[n]*hₛ[n] for 0≦n<2N−1 (8)

The convolution of each pair of input signal segment xᵣ[n] and impulse response segment hₛ[n] can be implemented by FFT with 2N−1 points. For simplicity, the complexity evaluation described here is based on radix-2 FFT and 2N-point FFT instead of (2N−1)-point FFT. Let

$$\begin{matrix}{\hat{x}}_{r} [ n ] = \{ \begin{matrix}x [ n + rN ] , & 0 \leq n \leq N - 1 \\ 0 , & N - 1 < n \leq 2 N - 1\end{matrix} , and & ( 9 ) \\ {\hat{h}}_{s} [ n ] = \{ \begin{matrix}h [ n + sN ] , & 0 \leq n \leq N - 1 \\ 0 , & N - 1 < n \leq 2 N - 1\end{matrix} . & ( 10 )\end{matrix}$$

Because the convolution in time domain is equivalent to the multiplication in frequency domain, (8) can be written as
Y_{r,s}[k]=Xᵣ[k]·Hₛ[k]; for 0≦k<2N, (11)
where Y_{r,s}[k], Xᵣ[k], and Hₛ[k] are the 2N-point FFT of y_{r,s}[n], \hat{x}ᵣ[n] and ĥₛ[n], respectively.

According to the above derivation, a fast algorithm is summarized as Algorithm 1 as follows:
Step 1: Store the FFT data of the segmented impulse response, Hₛ[k].
Step 2: Execute 2N-point FFT on the segmented input signals to obtain Xᵣ[k].
Step 3: Multiply M pairs of FFT data according to (11). The number of multiplications and additions for each input sample are 2M and 0, respectively. Because the input signal and the impulse response are both real signals, the negative frequency part data are the complex conjugate of the positive frequency part. By this property, only N+1 multiplications for each block are calculated. This reduces the number of multiplications for each input sample to M+M/N.
Step 4: Perform M times the inverse FFT to have the segmented data y_{r,s}[n] for different s.
Step 5: Overlap and add all the segmented y_{r,s}[n] to have the final y[n] according to (7).

The number of additions is 2(M−1) for each input sample.

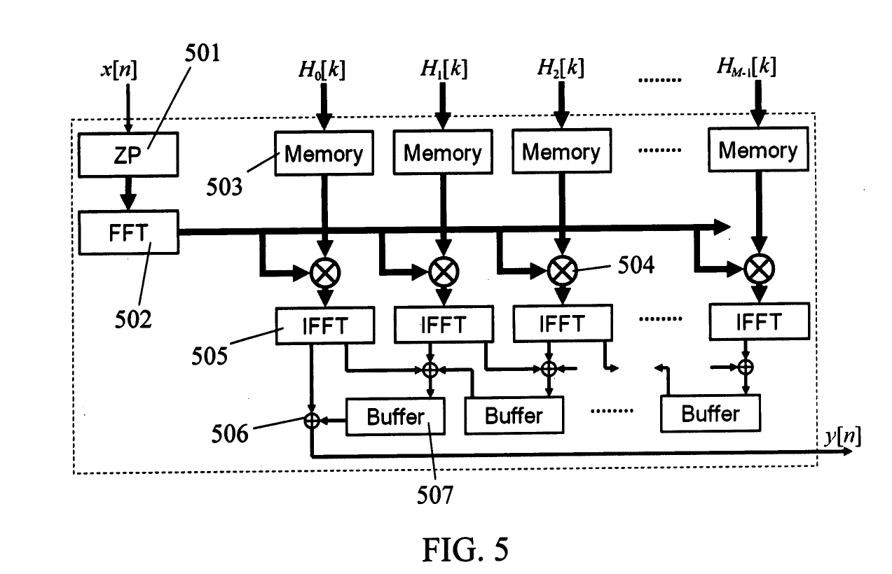

The number of complex multiplications needed per input sample is (1+M)FFT(2N)/N+M+M/N=(1+M)(log₂ N+1)/2−1/N+M. The algorithm has reduced the complexity of multiplications from L to 2(1+M)(log₂ N+1)−4/N+4M. The block diagram for this algorithm is shown in FIG. 5.

With reference to FIG. 5, the input signal x[n] is segmented by a segment processing unit 501. An FFT processor 502 transforms the segmented signal to frequency samples Xᵣ[k]. Frequency samples of the segmented impulse response Hₛ[k] are stored in the memory blocks 503. The frequency samples of the segmented signal are multiplied by frequency samples Hₛ[k] of the segmented impulse response in the multipliers 504. IFFT processors 505 then performs inverse FFT. The outputs of IFFT processors 505 are then overlapped and added by means of the adders 506 and buffers 507 to generate the final output signal y[n].

To reduce the complexity of Algorithm 1, the order of calculations in Algorithm 1 can be changed. Let p=r+s, (7) is rewritten as

$$\begin{matrix}y [ n ] = {\sum }_{p = s}^{∞} {\sum }_{s = 0}^{M - 1} {y}_{p - s , s} [ n - pN ] \\ = {\sum }_{p = s}^{∞} {\sum }_{s = 0}^{M - 1} {x}_{p - s} [ n - ( p - s ) N ] * {h}_{s} [ n - sN ] . & ( 12 ) \\ Define \\ {y}_{p} [ n ] = {\sum }_{s = 0}^{M - 1} {y}_{p - s , s} [ n - pN ] \\ = {\sum }_{s = 0}^{M - 1} {x}_{p - s} [ n - ( p - s ) N ] * {h}_{s} [ n - sN ] . & ( 13 ) \\ Hence , \\ y [ n ] = {\sum }_{p = s}^{∞} {y}_{p} [ n ] . & ( 14 )\end{matrix}$$

The nonzero values of yₚ[n] is only in the time interval [pN, pN+2N−2]. Let n′=n−pN, equation (13) can be rewritten as

$${y}_{p} [ {n}^{′} + pN ] = {\sum }_{s = 0}^{M - 1} {y}_{p - s , s} [ {n}^{′} ] . \qquad ( 15 )$$

Performing 2N-point FFT on (15) within the nonzero interval [0, 2N−1] leads to

$$\begin{matrix}{Y}_{p} [ k ] = {\sum }_{s = 0}^{M - 1} {Y}_{p - s , s} [ k ] \\ = {\sum }_{s = 0}^{M - 1} {X}_{p - s} [ k ] {H}_{s} [ k ] for 0 \leq k < 2 N - 1.\end{matrix} \qquad ( 16 )$$

The fast convolution, referred to as Algorithm 2, is summarized as follows:
Step 1: Store the FFT data of the segmented impulse response, Hₛ[k].
Step 2: Execute 2N-FFT on the segmented input signals to obtain Xᵣ[k].
Step 3: Multiply and add the two FFT data according to (16). The number of multiplications and additions is both M+M/N for each input sample.
Step 4: Perform inverse FFT to have the segmented data yₚ[n].
Step 5: Overlap and add all the segmented yₚ[n] to have the final y[n] according to (14).

The overlapping factor is 1 and hence has the complexity one.

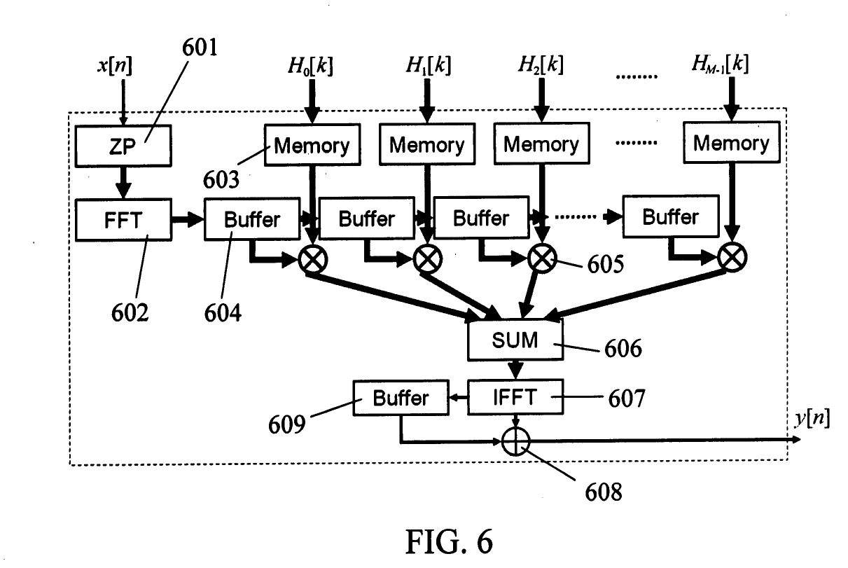

The block diagram of the fast convolution is illustrated in FIG. 6. The complexity of multiplications in Algorithm 2 is 2FFT(2N)/N+M+M/N, which has a factor of up to M times reduction compared to Algorithm 1.

With reference to FIG. 6, the input signal x[n] is segmented by a segment processing unit 601. An FFT processor 602 transforms the segmented input signal to frequency samples Xᵣ[k]. Frequency samples of segmented impulse response Hₛ[k] are stored in the memory blocks 603. The frequency samples of the segmented input signal are buffered by the buffering units 604 and multiplied by frequency samples Hₛ[k] of the segmented impulse response in the multipliers 605. The outputs of the multipliers 605 are added together in the summation unit 606. An IFFT processor 607 then performs inverse FFT on the output of the summation unit 606. The outputs of IFFT processors 607 are then overlapped and added by means of adder 608 and buffer 609 to generate the final output signal y[n].

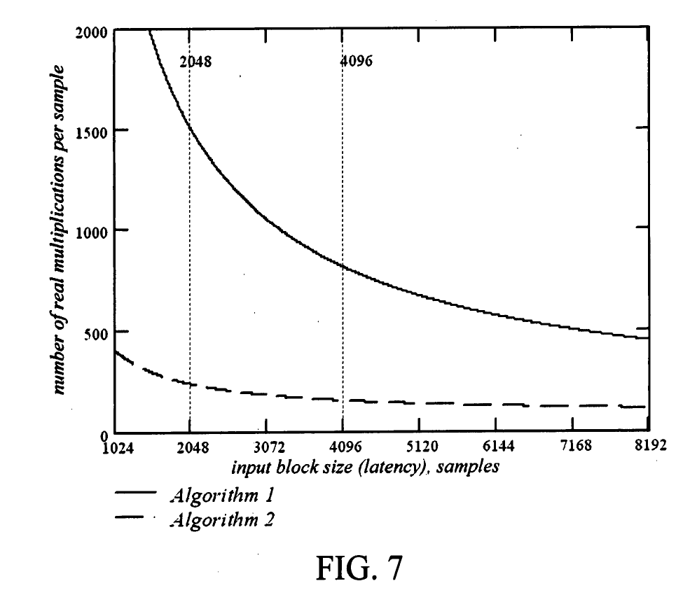

FIG. 7 illustrates the complexity of Algorithm 1 and Algorithm 2 using the number of real multiplications per sample with respect to the block length. When the input block size is set to 4096, Algorithm 2 needs about 150 real multiplications to convolve a signal with 88,200 samples of impulse response.

The overlap-and-save method is very similar to the overlap-and-add method except that the input blocks are overlapped, and the output blocks are not overlapped. In the overlap-and-save method, for each input block with a size N, the N samples are combined with the previous L−1 samples to form an overlapped input block with N+L−1 samples. Then circular convolution or linear convolution is performed on each overlapped input block. The first L−1 samples of each output block are discarded. If linear convolution is used, the tailing L−1 samples of each output block are also discarded. Finally, the output blocks are concatenated to form the result output.

To extend the overlap-and-save method to the segmented impulse response, the output signal in (7) is segmented by changing the parameter r′=r+s:

$$\begin{matrix}y [ n ] = {\sum }_{{r}^{′} = 0}^{∞} {\sum }_{s = 0}^{M - 1} {y}_{{r}^{′} - s , s} [ n - {r}^{′} N ] . \\ Define & ( 17 ) \\ {y}_{{r}^{′}}^{′} [ n - {r}^{′} N ] = {\sum }_{s = 0}^{M - 1} {y}_{{r}^{′} - s , s} [ n - {r}^{′} N ] , & ( 18 )\end{matrix}$$

where
y_{r′-s,s}[n]=x_{r′-s}[n]*hₛ[n] for 0≦n<2N−1. (19)
(17) can be represented as

$$y [ n ] = {\sum }_{{r}^{′} = 0}^{∞} {y}_{{r}^{′}}^{′} [ n - {r}^{′} N ] , \qquad ( 20 )$$

where y′_{r′}[n−r′N] is the summation of all blocks in time interval [r′N, (r′+2)N−1]. The form required in the overlap-and-save method should be to separate the output into the non-overlapping blocks yᵣ[n] that is,

$$\begin{matrix}y [ n ] = {\sum }_{p = 0}^{∞} {y}_{p} [ n - pN ] , \\ where & ( 21 ) \\ {y}_{p} [ n ] = \{ \begin{matrix}y [ n + pN ] , & 0 \leq n \leq N - 1 \\ 0 , & otherwise\end{matrix} . & ( 22 )\end{matrix}$$

Substituting (20) into (22) yields

$${y}_{p} [ n ] = {\sum }_{{r}^{′} = 0}^{∞} {y}_{{r}^{′}}^{′} [ n + pN - {r}^{′} N ] , 0 \leq n \leq N - 1. \qquad ( 23 )$$

Because each y_{r′}[n−pN−r′N] represents the values at time interval 2N, there is only two terms in the intervals [0, N−1]; that is
yₚ[n]=y′ₚ₋₁[n+N]+y′ₚ[n], 0≦n≦N−1. (24)
Substituting (18) and (19) into (24) yields

$$\begin{matrix}{y}_{p} [ n ] = {\sum }_{s = 0}^{M - 1} {x}_{p - s - 1} [ n + N ] * {h}_{s} [ n ] + {\sum }_{s = 0}^{M - 1} {x}_{p - s} [ n ] * {h}_{s} [ n ] , 0 \leq n \leq N - 1 & ( 25 ) \\ = {\sum }_{s = 0}^{M - 1} \{ {x}_{p - s - 1} [ n + N ] + {x}_{p - s} [ n ] \} * {h}_{s} [ n ] 0 \leq n \leq N - 1. & ( 26 )\end{matrix}$$

Let
x′ₚ[n]=xₚ₋₁[n+N]+xₚ[n], −N≦n≦N−1, (27)
where x′ₚ[n] is p-th overlapping block of the input signal x[n]. Then, (26) can be rewritten as

$${y}_{p} [ n ] = {\sum }_{s = 0}^{M - 1} {x}_{p - s}^{′} [ n ] * {h}_{s} [ n ] , 0 \leq n \leq N - 1. \qquad ( 28 )$$

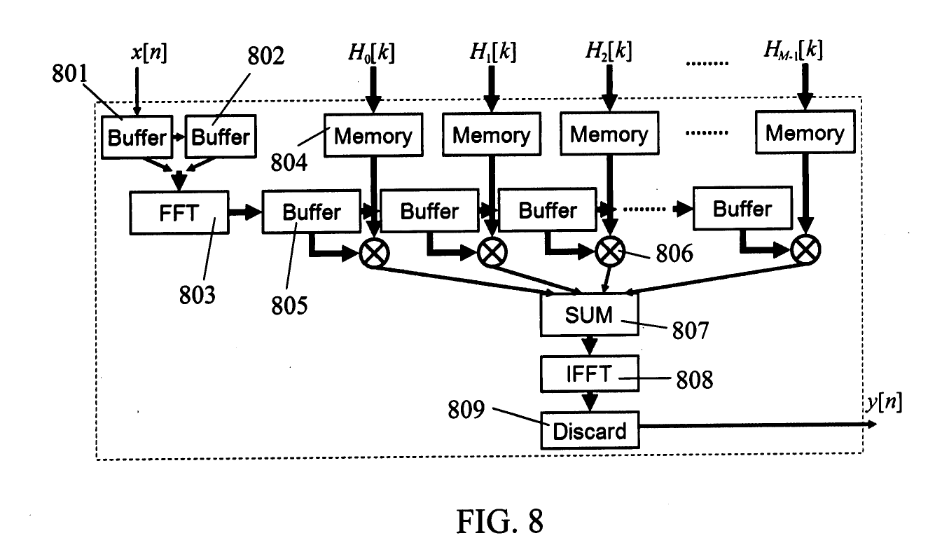

From (28), each non-overlapping output block can be calculated by evaluating the convolution for overlapping input blocks in the corresponding time interval. The implementations of algorithms described in the previous sections are also applicable to using overlap-and-save method. Algorithm 2 can be modified to use overlap-and-save method as following steps:
Step 1: Store the FFT data of the segmented impulse response, Hₛ[k].
Step 2: Execute 2N-FFT on the overlap-segmented input signals to obtain X′ₚ[k].
Step 3: Multiply and add the two FFT data according to (16). The number of multiplications and additions is both M+M/N for each input sample.
Step 4: Perform inverse FFT to have the segmented data yₚ[n].
Step 5: Discard the first N samples of yₚ[n] to have the final y[n] according to (28).
   The block diagram of the fast convolution is illustrated in FIG. 8. The complexity of multiplications is the same as Algorithm 2.

With reference to FIG. 8, the input signal x[n] is segmented and overlapped by segment buffers 801 and 802. An FFT processor 803 transforms the segmented signal to form overlapped-and-segmented frequency samples X′ₚ[k]. Frequency samples of segmented impulse response Hₛ[k] are stored in the memory blocks 804. The frequency samples of the segmented input signal are buffered by the buffering units 805 and multiplied by frequency samples Hₛ[k] of the segmented impulse response in the multipliers 806. The outputs of the multipliers 806 are added together in the summation unit 807. An IFFT processor 808 then performs inverse FFT on the output of the summation unit 807 to generate the segmented data yₚ[n]. The first N samples of yₚ[n] are discarded in the signal discarding unit 808 to output the final signal y[n].

Because the block size affects the latency of the system, it is important to shorten the block size to reduce the latency of the system although shortening the block size increases the complexity of the system. For efficiency, the block size is increased to an acceptable range to reduce the complexity. The acceptable latency in applications is about 150 ms which means about 6K samples in terms of 44,100 Hz sampling rate. From FIG. 7, the number of multiplications per sample needed by Algorithm 2 is more than 400 when the block size is set to 1024 samples. To find out the optimal block size, the minimum value of the complexity equation of Algorithm 2 is analyzed as follows.

From the previous discussion, it is known that the number of complex multiplications per sample is 2FFT(2N)/N+M+M/N. It is also known that for N-point real FFT, the number of complex multiplications needed is (N/4)(log₂ N+3)−1. let M be approximated as L/N. The complexity equation is
C(N)=log₂ N+4+(L−2)N⁻¹+LN⁻². (29)
Differentiating C(N) with respect to N leads to

$${C}^{′} ( N ) = \frac{1}{N ln 2} - ( L - 2 ) {N}^{- 2} - 2 {LN}^{- 3} . \qquad ( 30 )$$

The optimum block length Nₒₚₜ can be obtaining through C′(N)=0; that is

$$\begin{matrix}\frac{{N}_{opt}^{2}}{ln 2} - ( L - 2 ) {N}_{opt} - 2 L = 0. \\ Hence & ( 31 ) \\ {N}_{opt} = [ L - 2 + \sqrt{{( L - 2 )}^{2} + \frac{8 L}{ln 2}} ] \cdot \frac{ln 2}{2} . & ( 32 )\end{matrix}$$

In other words, the block length with best computation efficiency can be obtained if the filter length or the reverberation length is known. For example, when L=88200, Nₒₚₜ≈61140. N should be limited to be the power of two and the most typical reverberation length is in the range of 2-3 seconds. Another important issue is that the length of the filter is directly proportional to the block length. Furthermore, from FIG. 7, the complexity reduction ratio for N above 4000 is less than 10%. Hence, a value of 4096 for N is a good tradeoff for most environments.

Because the FFT needs to accumulate a segment to begin the FFT computation, the FFT-based convolution introduced an additional algorithm delay or latency by one FFT block, i.e., N. In some real-time applications like interactive environment, the latency should be limited. In the literature, there have been methods developed to shorten the latency of the filter by using time domain filter with low latency to compute the output of the first impulse response segment.

To remove the latency of the FFT-based convolution filters, they can be modified by combining with direct convolution to remove the latency. This invention also provides a method to remove the latency of Algorithm 2 so that the demand on the processor is uniform over time.

Considering Algorithm 2, to shorten the latency, direct convolution is used to calculate the output segment of the first impulse response segment. From (25), the output segment yₚ[n] can be expressed as

$$\begin{matrix}{y}_{p} [ n ] = {\sum }_{k = 0}^{N - 1} x [ n + pN - k ] h [ k ] + \\ {\sum }_{s = 1}^{M - 1} {x}_{p - s - 1} [ n + N ] * {h}_{s} [ n ] + {\sum }_{s = 1}^{M - 1} {x}_{p - s} [ n ] * {h}_{s} [ n ] .\end{matrix} \qquad ( 33 )$$

For the first sample of yₚ[n], yₚ[0]=y[pN], the inputs of the computation are xₖ[n], p−1≧k≧p−M+1 and x[n], pN≧n≧pN−N+1. The computation of

$${\sum }_{s = 1}^{M - 1} {x}_{p - s - 1} [ n + N ] * {h}_{s} [ n ]$$

is completed while computing yₚ₋₁[n] if the overlap-and-add method is used. Because these inputs are already available when x[pN] is received, yₚ[0] can be calculated without waiting for any other input samples and so are other samples in yₚ[n].

Although the implementation of (33) can remove the latency, the computation of xₚ₋₁[n]*h₁[n] can only be calculated after the sample x[N−1] including the last sample of xₚ₋₁[n] is available. If the application is to be without any latency, the computation has to be completed in a sampling period. This causes the demand on the processor to become non-uniform over time. To make the demand on the processor uniform, the direct convolution to calculate the output of the first two segments of impulse response can be used. Thus (33) can be expressed as

$${y}_{p} [ n ] = {\sum }_{k = 0}^{2 N - 1} x [ n + pN - k ] h [ k ] + {\sum }_{s = 2}^{M - 1} {x}_{p - s - 1} [ n + N ] * {h}_{s} [ n ] + {\sum }_{s = 2}^{M - 1} {x}_{p - s} [ n ] * {h}_{s} [ n ] \qquad ( 34 )$$

After this modification, the computation of FFT convolution can be finished in an input segment of time, just like the original algorithm.

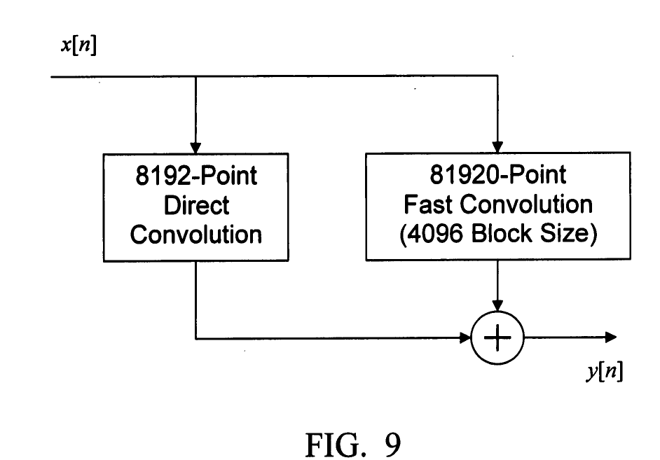

It is known that the direct convolution of N-point impulse response needs N multiplications for each output sample. Thus, after this modification the computational power requirement increases. For example, using Algorithm 2 with 4,096 block size for 88,200 samples of impulse response, it originally takes about 100 multiplications to compute an output sample. After this modification, it may take more than 8,000 multiplications to calculate an output sample. FIG. 9 shows the block diagram of the zero-delay fast convolution implementation for 88,200 (90,112) samples of impulse response.

To reduce the complexity of the implementation shown in FIG. 9, the block size can be reduced. The complexity equation of the zero delay implementation can be expressed as
C_{ZD}(N)=4 log₂ N+16+4(L−2N−2)N⁻¹+4(L−2N)N⁻²+2N (35)
From (54), it can be found that the optimal block size is 512, and the complexity is about 1760 multiplications per sample.

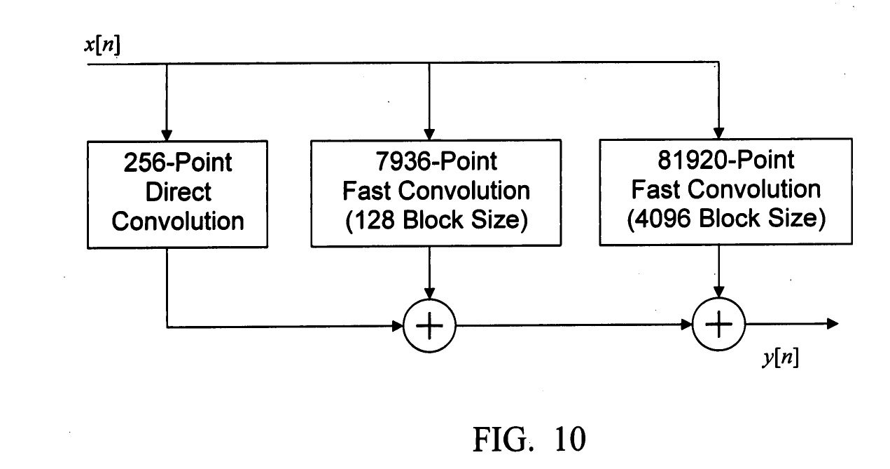

Another method to reduce the complexity is that the output of the first 2 segments of impulse response can be calculated with a smaller block size. As shown in FIG. 10, the first two segments are computed with a 256 point direct convolution and a 7936 point fast convolution which has a block size of 128. The other segments are still computed with a block size of 4096. With the implementation of FIG. 10, the complexity is reduced from more than 8000 to about 700 multiplications per sample.

According to this invention, a fast perceptual convolution is provided to reduce the computational complexity required by FIR-based reverberators. The conventional perceptual approach tries to change the impulse response in time domain to reduce the multiplications needed for the convolution method. The fast perceptual convolution of this invention is to reduce the multiplications needed in frequency domain for the FFT convolution methods by applying some threshold to truncate the segmented spectrum.

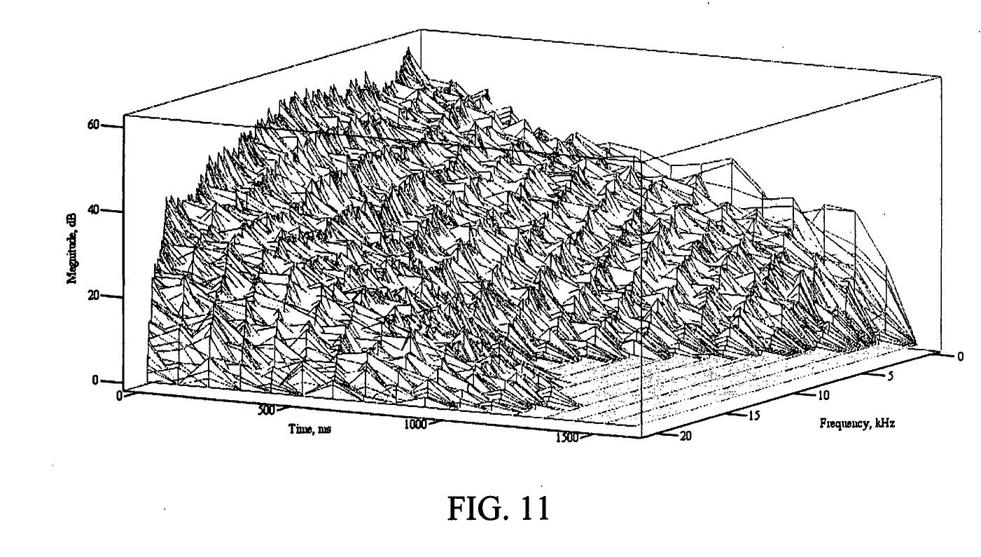

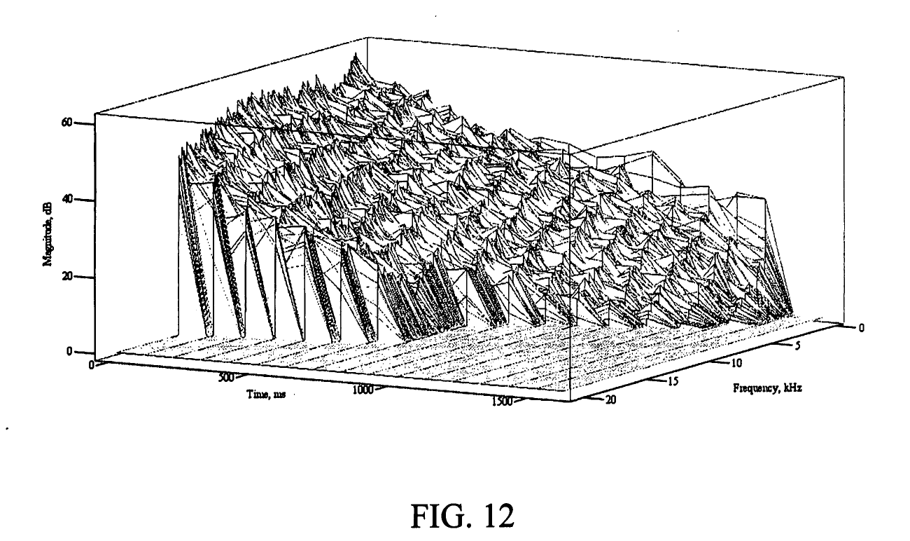

A threshold in quiet is the threshold that characterizes the minimum amount of energy needed in a pure tone detected by human hearing system in a noiseless environment. For the FFT-based method in the present invention, the segmented spectrum Hₛ[k] can be truncated by comparing the result with the threshold derived from the threshold in quiet. The approach can reduce the complexity required in the FFT-based method. FIG. 11 illustrates the magnitude response of Hₛ[k] with respect to k and s, it can be seen that the higher frequency part decays faster than the lower frequency part. After partitioning the impulse response, the magnitude of the higher frequency part of later blocks is very small. FIG. 12 illustrates the same magnitude response after applying the threshold in quite to cut the correspondent spectrum lines.

Considering (16), the output signal Yₚ[k] will not be perceptible if the energy is lower than the threshold in quiet. That is
|Yₚ[k]|≦Th[k]. (36)
where Th[k] is the threshold in quiet for a frequency k. Substituting (16) to (36) leads to

$$\vert {\sum }_{s = 0}^{M - 1} {X}_{p - s} [ k ] {H}_{s} [ k ] \vert \leq Th [ k ] , for 0 \leq k < 2 N - 1. \qquad ( 37 )$$

Assuming that the signal magnitude is lower than ρ, (37) is reduced to

$$\vert {\sum }_{s = 0}^{M - 1} {X}_{p - s} [ k ] {H}_{s} [ k ] \vert \leq ρ \vert {\sum }_{s = 0}^{M - 1} {H}_{s} [ k ] \vert \leq Th [ k ] , for 0 \leq k < 2 N - 1. \qquad ( 38 )$$

The sufficient condition for the above inequality on |Hₛ[k]| is

$$\vert {H}_{s} [ k ] \vert \leq \frac{Th [ k ]}{M ρ} , for 0 \leq k < 2 N - 1 \qquad ( 39 )$$

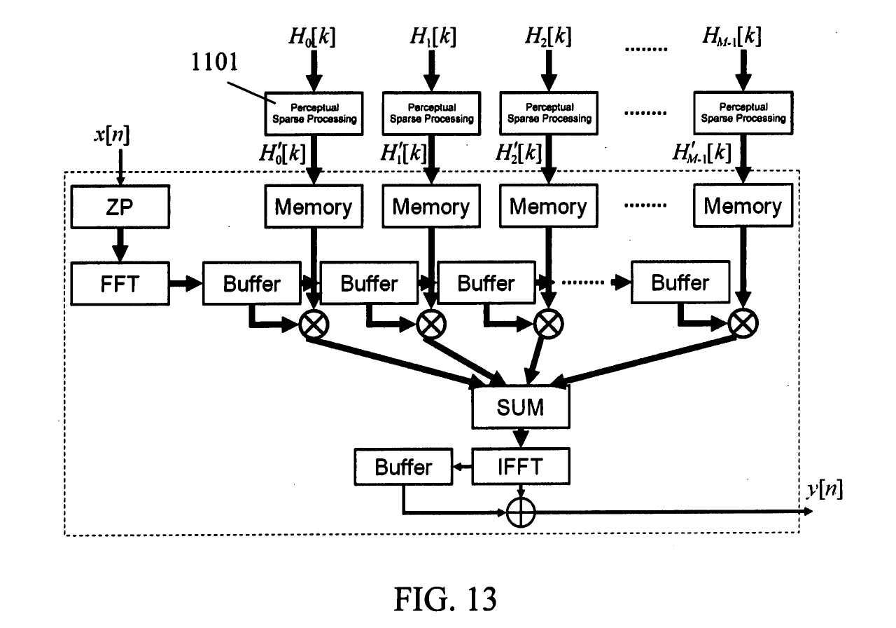

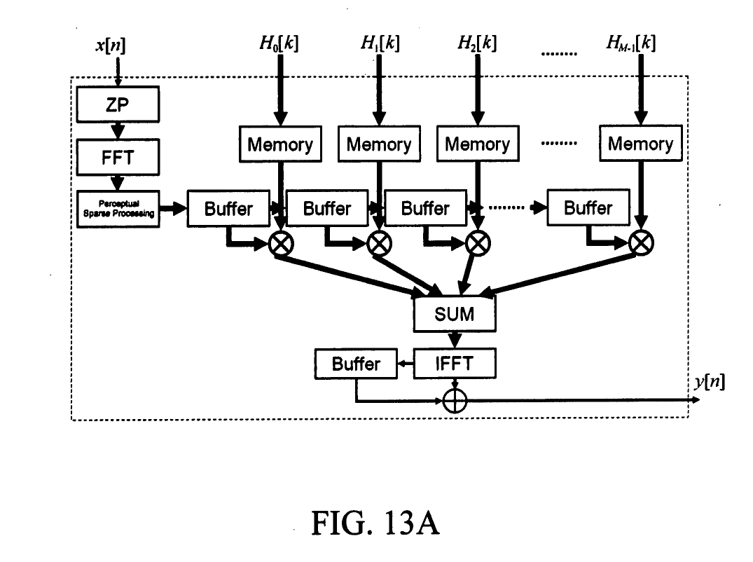

To implement the fast perceptual convolution, it is necessary to decide the frequency part that can be removed. In Step 1 of Algorithm 1 or 2, the frequency domain data of each small block in the impulse response can be obtained. For each small block, the magnitude of each frequency sample is calculated. Then, the highest frequencies are scanned to find a frequency point in which its magnitude is equal or greater than the perceptual threshold. In Step 3 of both algorithms, the multiplications for those frequencies that are higher than the frequency point corresponding to each block found in Step 1 can be ignored. The block diagram of fast perceptual convolution is shown in FIG. 13.

FIG. 13 illustrates how the fast perceptual convolution is applied to the fast convolution algorithm, i.e., Algorithm 2 shown in FIG. 6. As shown in FIG. 13, the perceptual sparse processing units 1101 first removes the higher frequency parts of the segmented spectrum Hₛ[k] that are not perceptible. Once the segmented spectrum Hₛ[k] is truncated as H′ₛ[k], the remaining processing is identical to what is shown in FIG. 6. Although no block diagrams are shown to illustrate the application of fast perceptual convolution to the algorithms illustrated in FIG. 5 and FIG. 8, it is clear that perceptual sparse processing units can also be added to them for truncating the segmented spectrum Hₛ[k] that are not perceptible.

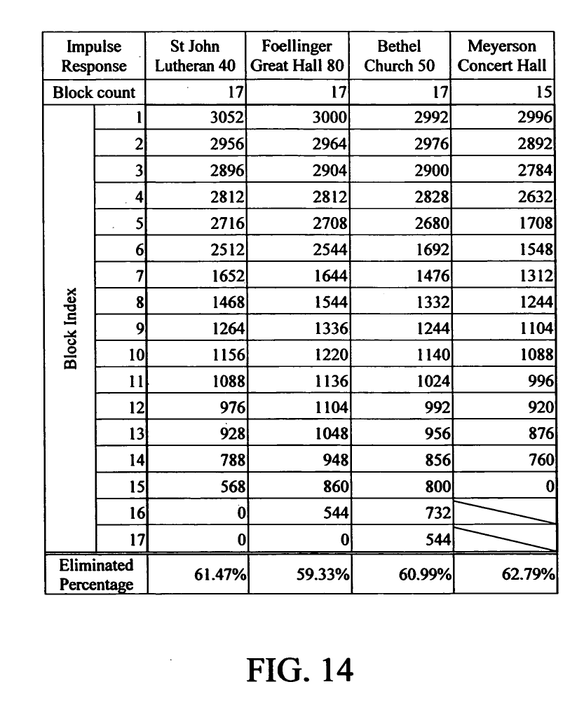

FIG. 14 shows the cutoff frequency point found in each block of 4 different impulse responses. For those impulse responses, more than 50% of multiplications in frequency domain has been eliminated. For some blocks, the multiplications for the whole block can be removed. FIG. 12 shows the same impulse response as that is shown in FIG. 11 after removing ignored frequencies.

Instead of truncating the segmented spectrum Hₛ[k] that are not perceptible, the removal of the higher frequencies that are greater than the perceptual threshold can also be accomplished by removing the frequency spectra of the input signals. In other words, the perceptual sparse processing can be implemented after the FFT of the input signals as shown in FIG. 13(A).

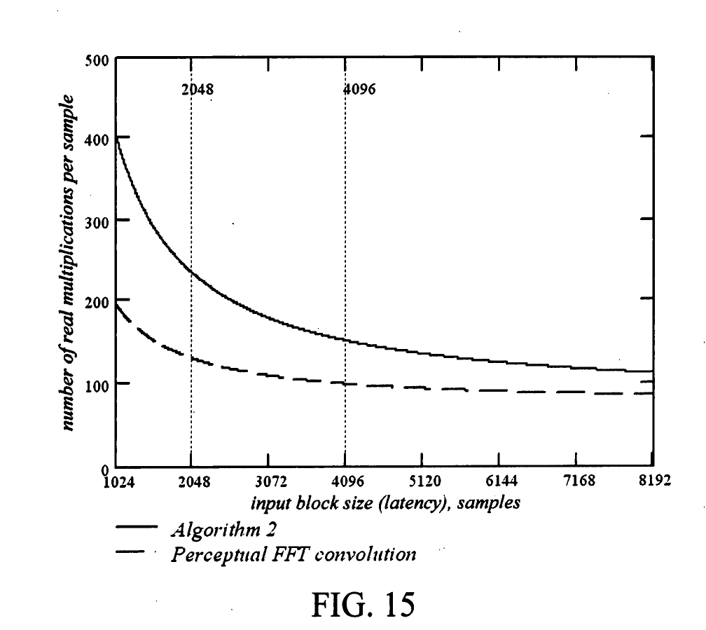

Assuming that 60% of multiplications in frequency domain is removed, the number of multiplications needed for fast perceptual convolution by modifying the complexity from Algorithm 2 is calculated and illustrated in FIG. 15. From the result, the fast perceptual convolution requires about 98 real multiplications per sample to convolve with 88,200 samples of impulse response.

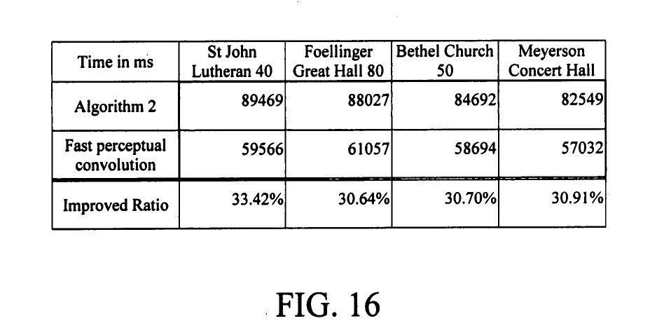

To evaluate the improvement in real-time systems, an experimental application has been built for evaluation. The application used two methods, the fast perceptual convolution method and Algorithm 2 respectively, to process some samples for comparison. The input block size is set to 4,096. And the test is to process single channel, 4,096×20,000=81,920,000 samples of input, which is about 30 minutes of samples with 44,100 Hz sampling rate. The test is run on a PC with 1 GHz Pentium. The result is listed in FIG. 16. As can be seen, the improved ratio is more than 30% in all cases.

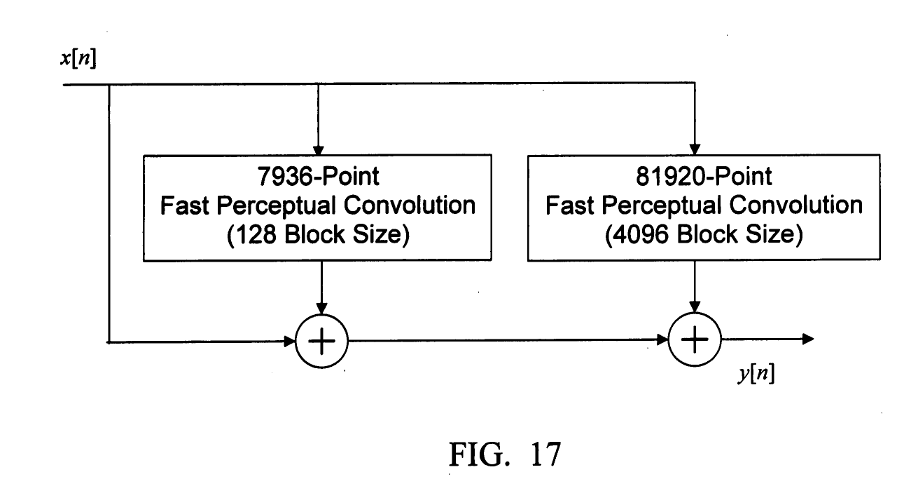

Fast perceptual convolution can also be applied to the low latency implementations discussed earlier. Using the implementation shown in FIG. 10 as an example, the direct convolution part can be removed because the first 256 samples of most impulse response are belonging to the earlier delay part and the results are usually below the perceptual threshold. The implementation with fast perceptual convolution is illustrated in FIG. 17. For the impulse response “St. John Lutheran 40”, the complexity can be reduced from 694 to about 324 multiplications per sample.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A method for efficient convolution, comprising the steps of:
preparing a plurality of segmented perceptual response frequency spectra by removing high frequency components from a plurality of segmented response frequency spectra;
generating a plurality of segmented input frequency spectra from a plurality of segmented input signals; and
performing a frequency domain convolution method to generate convoluted signals using said plurality of segmented perceptual response frequency spectra and said plurality of segmented input frequency spectra;
wherein said plurality of segmented perceptual response frequency spectra are generated by removing high frequency components from said plurality of segmented response frequency spectra based on a threshold.

2. The method for efficient convolution as claimed in claim 1, wherein said efficient convolution is used for generating artificial room reverberation and said threshold is based on a threshold in quiet, said threshold being determined by the minimum amount of energy in a pure tone detected by a human hearing system in a noiseless environment.

3. The method for efficient convolution as claimed in claim 1, wherein said frequency domain convolution method is an overlap-and-add method by using FFT.

4. The method for generating efficient convolution as claimed in claim 1, wherein said frequency domain convolution method is an overlap-and-save method by using FFT.

5. The method for efficient convolution as claimed in claim 1, wherein said segmented input signals have a segment size for segmentation and in the step of performing a frequency domain convolution method to generate convoluted signals, first and second segments of convoluted signals are generated by convolution using a block size smaller than the segment size.

6. A method for efficient convolution, comprising the steps of:
preparing an impulse response h[n];
segmenting said impulse response into M segmented impulse responses hₛ[n], wherein
$${h}_{s} [ n ] = \{ \begin{matrix}h [ n + sN ] , & 0 \leq n \leq N - 1 \\ 0 , & otherwise\end{matrix} , s = 0 , 1 , 2 , … , M - 1 ;$$
transforming said M segmented impulse responses hₛ[n] by DFT to form M segmented frequency spectra Hₛ[k] with 0≦k<2N;
removing high frequency components from said M segmented frequency spectra Hₛ[k] based on a threshold to form M sets of segmented perceptual response frequency spectra H′ₛ[k];
receiving and segmenting an input signal x[n] into a plurality of segmented input signals xᵣ[n], wherein
$${x}_{r} [ n ] = \{ \begin{matrix}x [ n + rN ] , & 0 \leq n \leq N - 1 \\ 0 , & otherwise\end{matrix} , r = 0 , 1 , 2 , … , ∞ ;$$
transforming each segmented input signal xᵣ[n] by DFT to form a segmented input frequency spectrum xᵣ[k];
multiplying said segmented input frequency spectrum Xᵣ[k] with said M sets of segmented perceptual response frequency spectra H′ₛ[k] for s=0, 1, 2, . . . , M−1 to form M segmented output frequency spectra Y_{r,s}[k]=Xᵣ[k]·H′ₛ[k];
inverse transforming said M output frequency spectra Y_{r,s}[k] to form M segmented output signals y_{r,s}[n]; and
performing overlap-and-add summation of said M segmented output signals y_{r,s}[n] to form a final output signal y[n] according to
$$y [ n ] = {\sum }_{r = 0}^{∞} {\sum }_{s = 0}^{M - 1} {y}_{r , s} [ n - rN - sN ] .$$

7. The method for efficient convolution according to claim 6, wherein said impulse response has a length L and
$$M = ⌈ \frac{L}{N} ⌉$$
is a smallest integer larger than L divided by N.

8. A method for efficient convolution, comprising the steps of:
preparing an impulse response h[n];
segmenting said impulse response into M segmented impulse responses hₛ[n], wherein
$${h}_{s} [ n ] = \{ \begin{matrix}h [ n + sN ] , & 0 \leq n \leq N - 1 \\ 0 , & otherwise\end{matrix} , s = 0 , 1 , 2 , … , M - 1 ;$$
transforming said M segmented impulse responses hₛ[n] by DFT to form M segmented frequency spectra Hₛ[k] with 0≦k<2N;
removing high frequency components from said M segmented frequency spectra Hₛ[k] based on a threshold to form M sets of segmented perceptual response frequency spectra H′ₛ[k];
receiving and segmenting an input signal x[n] into a plurality of segmented input signals xᵣ[n], wherein
$${x}_{r} [ n ] = \{ \begin{matrix}x [ n + rN ] , & 0 \leq n \leq N - 1 \\ 0 , & otherwise\end{matrix} , r = 0 , 1 , 2 , … , ∞ ;$$
transforming each segmented input signal xᵣ[n] by FFT to form a segmented input frequency spectrum Xᵣ[k];
buffering said segmented input frequency spectrum to form buffered segmented input frequency spectra Xₚ₋ₛ[k] for s=0, 1, 2, . . . , M and p=0, 1, 2, . . . , ∞;
multiplying said M sets of segmented perceptual response frequency spectra H′ₛ[k] with last buffered M segmented input frequency spectra Xₚ₋ₛ[k] to form products Xₚ₋ₛ[k]·H′ₛ[k] for s=0, 1, 2, . . . , M−1 and adding said products together to form a segmented output frequency spectrum
$${Y}_{p} [ k ] = {\sum }_{s = 0}^{M - 1} {X}_{p - s} [ k ] {H}_{s}^{′} [ k ] , for 0 \leq k < 2 N - 1 ;$$
inverse transforming said segmented output frequency spectrum Yₚ[k] to form segmented output signals yₚ[n]; and
performing overlap-and-add summation of said M segmented output signals yₚ[n] to form a final output signal y[n] according to
$$y [ n ] = {\sum }_{p = s}^{∞} {y}_{p} [ n ] .$$

9. The method for efficient convolution according to claim 8, wherein said impulse response has a length L and
$$M = ⌈ \frac{L}{N} ⌉$$
is a smallest integer larger than L divided by N.

10. A method for efficient convolution, comprising the steps of:
preparing an impulse response h[n] of;
segmenting said impulse response into M segmented impulse responses hₛ[n], wherein
$${h}_{s} [ n ] = \{ \begin{matrix}h [ n + sN ] , & 0 \leq n \leq N - 1 \\ 0 , & otherwise\end{matrix} , s = 0 , 1 , 2 , … , M - 1 ;$$
transforming said segmented impulse responses hₛ[n] by DFT to form M segmented frequency spectra Hₛ[k] with 0≦k<2N;
removing high frequency components from said segmented frequency spectra Hₛ[k] based on a threshold to form M sets of segmented perceptual response frequency spectra H′ₛ[k];
receiving and segmenting an input signal x[n] into a plurality of segmented input signals xᵣ[n], wherein
$${x}_{r} [ n ] = \{ \begin{matrix}x [ n + rN ] , & 0 \leq n \leq N - 1 \\ 0 , & otherwise\end{matrix} , r = 0 , 1 , 2 , … , ∞ ;$$
overlapping and adding adjacent segmented input signals to form a plurality of overlapped-and-segmented input signals x′ₚ[n]=xₚ₋₁[n+N]+xₚ[n], wherein −N≦n≦N−1 and p=0, 1, 2, . . . , ∞;
transforming each overlapped-and-segmented input signal x′ₚ[n] by FFT to form a segmented input frequency spectrum X′ₚ[k];
buffering said segmented input frequency spectrum to form buffered segmented input frequency spectra X′ₚ₋ₛ[k] for s=0, 1, 2, . . . , M and p=0, 1, 2, . . . , ∞;
multiplying said M sets of segmented perceptual response frequency spectra H′ₛ[k] with last buffered M segmented input frequency spectra X′ₚ₋ₛ[k] to form products X′ₚ₋ₛ[k]·H′ₛ[k] for s=0, 1, 2, . . . , M−1 and adding said products together to form a segmented output frequency spectrum
$${Y}_{p} [ k ] = {\sum }_{s = 0}^{M - 1} {X}_{p - s}^{′} [ k ] {H}_{s}^{′} [ k ] , for 0 \leq k < 2 N - 1 ;$$
inverse transforming said segmented output frequency spectrum Yₚ[k] to form segmented output signals yₚ[n]; and
generating a final output signal y[n] by discarding first N samples of yₚ[n].

11. The method for efficient convolution according to claim 10, wherein said impulse response has a length L and
$$M = ⌈ \frac{L}{N} ⌉$$
is a smallest integer larger than L divided by N.

12. An apparatus for efficient convolution, comprising:
a plurality of perceptual sparse processing units for removing high frequency components from a plurality of segmented response frequency spectra to form a plurality of segmented perceptual response frequency spectra; and
a FIR-filter receiving said plurality of segmented perceptual response frequency spectra;
wherein each of said perceptual sparse processing units removes high frequency components from a segmented response frequency spectrum based on a threshold.

13. The apparatus for efficient convolution as claimed in claim 12, wherein said FIR filter is implemented by a frequency domain convolution method based on an overlap-and-add method.

14. The apparatus for efficient convolution as claimed in claim 12, wherein said FIR-filter is implemented by a frequency domain convolution method based on an overlap-and-save method.

15. The apparatus for efficient convolution as claimed in claim 12, wherein said FIR-filter comprises a first section in which frequency domain convolution is computed with a first block size for reducing latency and a second section in which frequency domain convolution is computed with a second block size.

16. An apparatus for efficient convolution, comprising:
a segmenting unit for segmenting an input signal into segmented input signals;
a FFT processor for performing fast Fourier transform on each segmented input signal to a segmented input frequency spectrum;
a plurality of perceptual sparse processing units for removing high frequency components from a plurality of segmented response frequency spectra to form a plurality of segmented perceptual response frequency spectra;
a plurality of memory devices for storing said plurality of segmented perceptual response frequency spectra;
a plurality of multipliers for multiplying said segmented input frequency spectrum with said plurality of segmented perceptual response frequency spectra to form a plurality of segmented output frequency spectra;
a plurality of IFFT processors for performing inverse fast Fourier transform on said plurality of segmented output frequency spectra to form a plurality of segmented output signals; and
a plurality of overlap-and-add units for overlapping and adding said plurality of segmented output signals to form a final output signal;
wherein each of said perceptual sparse processing units removes high frequency components from a segmented response frequency spectrum based on a threshold.

17. An apparatus for efficient convolution, comprising:
a segmenting unit for segmenting an input signal into segmented input signals;
a FFT processor for performing fast Fourier transform on each segmented input signal to a segmented input frequency spectrum;
a plurality of perceptual sparse processing units for removing high frequency components from a plurality of segmented response frequency spectra to form a plurality of segmented perceptual response frequency spectra;
a plurality of memory devices for storing said plurality of segmented perceptual response frequency spectra;
a plurality of buffers for buffering a plurality of segmented input frequency spectra;
a plurality of multipliers for multiplying said buffered plurality of segmented input frequency spectra with said plurality of segmented perceptual response frequency spectra to form a plurality of segmented output frequency spectra;
a summation unit for adding said plurality of segmented output frequency spectra to form an output frequency spectrum;
an IFFT processor for performing inverse fast Fourier transform on said output frequency spectrum to form an output signal; and
an overlap-and-add unit for overlapping and adding said output signal to form a final output signal;
wherein each of said perceptual sparse processing units removes high frequency components from a segmented response frequency spectrum based on a threshold.

18. An apparatus for efficient convolution, comprising:
an overlapping and segmenting unit for overlapping and segmenting an input signal into overlapped-and-segmented input signals;
a FFT processor for performing fast Fourier transform on each overlapped-and-segmented input signal to a segmented input frequency spectrum;
a plurality of perceptual sparse processing units for removing high frequency components from a plurality of segmented response frequency spectra to form a plurality of segmented perceptual response frequency spectra;
a plurality of memory devices for storing said plurality of segmented perceptual response frequency spectra;
a plurality of buffers for buffering a plurality of segmented input frequency spectra;
a plurality of multipliers for multiplying said buffered plurality of segmented input frequency spectra with said plurality of segmented perceptual response frequency spectra to form a plurality of segmented output frequency spectra;
a summation unit for adding said plurality of segmented output frequency spectra to form an output frequency spectrum;
an IFFT processor for performing inverse fast Fourier transform on said output frequency spectrum to form an output signal; and
a discarding unit for discarding a number of samples from said output signal to form a final output signal;
wherein each of said perceptual sparse processing units removes high frequency components from a segmented response frequency spectrum based on a threshold.

19. A method for efficient convolution, comprising the steps of:
preparing a plurality of segmented response frequency spectra;
generating a plurality of segmented input frequency spectra from a plurality of segmented input signals;
removing high frequency components from said plurality of segmented input frequency spectra to form a plurality of segmented perceptual input frequency spectra; and
performing a frequency domain convolution method to generate convoluted signals using said plurality of segmented response frequency spectra and said plurality of segmented perceptual input frequency spectra;
wherein said plurality of segmented perceptual input frequency spectra are generated by removing high frequency components from said plurality of segmented input frequency spectra based a threshold.

20. The method for efficient convolution as claimed in claim 19, wherein said efficient convolution is used for generating artificial room reverberation and said threshold is based on a threshold in quiet, said threshold being determined by the minimum amount of energy in a pure tone detected by a human hearing system in a noiseless environment.

21. The method for efficient convolution as claimed in claim 19, wherein said frequency domain convolution method is an overlap-and-add method by using FFT.

22. The method for generating efficient convolution as claimed in claim 1, wherein said frequency domain convolution method is an overlap-and-save method by using FFT.

23. The method for efficient convolution as claimed in claim 19, wherein said segmented input signals have a segment size for segmentation and in the step of performing a frequency domain convolution method to generate convoluted signals, first and second segments of convoluted signals are generated by convolution using a block size smaller than the segment size.

24. A method for efficient convolution, comprising the steps of:
preparing an impulse response h[n];
segmenting said impulse response into M segmented impulse responses hₛ[n], wherein
$${h}_{s} [ n ] = \{ \begin{matrix}h [ n + sN ] , & 0 \leq n \leq N - 1 \\ 0 , & otherwise\end{matrix} , s = 0 , 1 , 2 , … , M - 1 ;$$
transforming said M segmented impulse responses hₛ[n] by DFT to form M segmented response frequency spectra Hₛ[k] with 0≦k<2N;
receiving and segmenting an input signal x[n] into a plurality of segmented input signals xᵣ[n], wherein
$${x}_{r} [ n ] = \{ \begin{matrix}x [ n + rN ] , & 0 \leq n \leq N - 1 \\ 0 , & otherwise\end{matrix} , r = 0 , 1 , 2 , … , ∞ ;$$
transforming each segmented input signal xᵣ[n] by DFT to form a segmented input frequency spectrum Xᵣ[k];
removing high frequency components from said segmented input frequency spectra Xᵣ[k] based on a threshold to a segmented perceptual input frequency spectra X′ᵣ[k];
multiplying said segmented perceptual input frequency spectrum X′ᵣ[k] with said M sets of segmented response frequency spectra Hₛ[k] for s=0, 1, 2, . . . , M−1 to form M segmented output frequency spectra Y_{r,s}[k]=X′ᵣ[k]·Hₛ[k];
inverse transforming said M output frequency spectra Y_{r,s}[k] to form M segmented output signals y_{r,s}[n]; and
performing overlap-and-add summation of said M segmented output signals y_{r,s}[n] to form a final output signal y[n] according to
$$y [ n ] = {\sum }_{r = 0}^{∞} {\sum }_{s = 0}^{M - 1} {y}_{r , s} [ n - rN - sN ] .$$

25. The method for efficient convolution according to claim 24, wherein said impulse response has a length L and
$$M = ⌈ \frac{L}{N} ⌉$$
is a smallest integer larger than L divided by N.

26. A method for efficient convolution, comprising the steps of: preparing an impulse response h[n];
segmenting said impulse response into M segmented impulse responses hₛ[n], wherein
$${h}_{s} [ n ] = \{ \begin{matrix}h [ n + sN ] , & 0 \leq n \leq N - 1 \\ 0 , & otherwise\end{matrix} , s = 0 , 1 , 2 , … , M - 1 ;$$
transforming said M segmented impulse responses hₛ[n] by DFT to form M segmented response frequency spectra Hₛ[k] with 0≦k<2N;
receiving and segmenting an input signal x[n] into a plurality of segmented input signals xᵣ[n], wherein
$${x}_{r} [ n ] = \{ \begin{matrix}x [ n + rN ] , & 0 \leq n \leq N - 1 \\ 0 , & otherwise\end{matrix} , r = 0 , 1 , 2 , … , ∞ ;$$
transforming each segmented input signal xᵣ[n] by FFT to form a segmented input frequency spectrum Xᵣ[k];
removing high frequency components from said segmented input frequency spectrum Xᵣ[k] based on a threshold to form a segmented perceptual input frequency spectrum X′ᵣ[k];
buffering said segmented perceptual input frequency spectrum to form buffered segmented perceptual input frequency spectra X′ₚ₋ₛ[k] for s=0, 1, 2, . . . , M and p=0, 1, 2, . . . , ∞;
multiplying said M sets of segmented response frequency spectra Hₛ[k] with last buffered M segmented perceptual input frequency spectra X′ₚ₋ₛ[k] to form products X′ₚ₋ₛ[k]·Hₛ[k] for s=0, 1, 2, . . . , M−1 and adding said products together to form a segmented output frequency spectrum
$${Y}_{p} [ k ] = {\sum }_{s = 0}^{M - 1} {X}_{p - s}^{′} [ k ] {H}_{s} [ k ] , for 0 \leq k < 2 N - 1 ;$$
inverse transforming said segmented output frequency spectrum Yₚ[k] to form segmented output signals yₚ[n]; and
performing overlap-and-add summation of said M segmented output signals yₚ[n] to form a final output signal y[n] according to
$$y [ n ] = {\sum }_{p = s}^{∞} {y}_{p} [ n ] .$$

27. The method for efficient convolution according to claim 26, wherein said impulse response has a length L and
$$M = ⌈ \frac{L}{N} ⌉$$
is a smallest integer larger than L divided by N.

28. A method for efficient convolution, comprising the steps of:
preparing an impulse response h[n] of;
segmenting said impulse response into M segmented impulse responses hₛ[n], wherein
$${h}_{s} [ n ] = \{ \begin{matrix}h [ n + sN ] , & 0 \leq n \leq N - 1 \\ 0 , & otherwise\end{matrix} , s = 0 , 1 , 2 , … , M - 1 ;$$
transforming said segmented impulse responses hₛ[n] by DFT to form M segmented response frequency spectra Hₛ[k] with 0≦k<2N;
receiving and segmenting an input signal x[n] into a plurality of segmented input signals xᵣ[n], wherein
$${x}_{r} [ n ] = \{ \begin{matrix}x [ n + rN ] , & 0 \leq n \leq N - 1 \\ 0 , & otherwise\end{matrix} , r = 0 , 1 , 2 , … , ∞ ;$$
overlapping and adding adjacent segmented input signals to form a plurality of overlapped-and-segmented input signals x′ₚ[n]=xₚ₋₁[n+N]+xₚ[n], −N≦n≦N−1;
transforming each overlapped-and-segmented input signal x′ₚ[n] by FFT to form a segmented input frequency spectrum X′ₚ[k];
removing high frequency components from said segmented input frequency spectrum X′ₚ[k] based on a threshold to form a segmented perceptual input frequency spectrum X″ₚ[k];
buffering said segmented perceptual input frequency spectrum to form buffered segmented perceptual input frequency spectra X″ₚ₋ₛ[k] for s=0, 1, 2, . . . , M and p=0, 1, 2, . . . , ∞;
multiplying said M sets of segmented response frequency spectra Hₛ[k] with last buffered M segmented perceptual input frequency spectra X″ₚ₋ₛ[k] to form products X″ₚ₋ₛ[k]·Hₛ[k] for s=0, 1, 2, . . . , M−1 and adding said products together to form a segmented output frequency spectrum
$${Y}_{p} [ k ] = {\sum }_{s = 0}^{M - 1} {X}_{p - s}^{″} [ k ] {H}_{s} [ k ] , for 0 \leq k < 2 N - 1 ;$$
inverse transforming said segmented output frequency spectrum Yₚ[k] to form segmented output signals yₚ[n]; and
generating a final output signal y[n] by discarding first N samples of yₚ[n].

29. The method for efficient convolution according to claim 28, wherein said impulse response has a length L and
$$M = ⌈ \frac{L}{N} ⌉$$
is a smallest integer larger than L divided by N.

30. An apparatus for efficient convolution, comprising:
a segmenting unit for segmenting an input signal into segmented input signals;
a FFT processor for performing fast Fourier transform on each segmented input signal to a segmented input frequency spectrum;
a perceptual sparse processing unit for removing high frequency components from said segmented input frequency spectrum to form a segmented perceptual input frequency spectrum;
a plurality of memory devices for storing a plurality of segmented response frequency spectra;
a plurality of multipliers for multiplying said segmented perceptual input frequency spectrum with said plurality of segmented response frequency spectra to form a plurality of segmented output frequency spectra;
a plurality of IFFT processors for performing inverse fast Fourier transform on said plurality of segmented output frequency spectra to form a plurality of segmented output signals; and
a plurality of overlap-and-add units for overlapping and adding said plurality of segmented output signals to form a final output signal;
wherein said perceptual sparse processing unit removes high frequency components from said segmented input frequency spectrum based on a threshold.

31. An apparatus for efficient convolution, comprising:
a segmenting unit for segmenting an input signal into segmented input signals;
a FFT processor for performing fast Fourier transform on each segmented input signal to a segmented input frequency spectrum;
a perceptual sparse processing unit for removing high frequency components from said segmented input frequency spectrum to form a segmented perceptual input frequency spectrum;
a plurality of memory devices for storing a plurality of segmented response frequency spectra;
a plurality of buffers for buffering a plurality of said segmented perceptual input frequency spectra;
a plurality of multipliers for multiplying said buffered plurality of segmented perceptual input frequency spectra with said plurality of segmented response frequency spectra to form a plurality of segmented output frequency spectra;
a summation unit for adding said plurality of segmented output frequency spectra to form an output frequency spectrum;
an IFFT processor for performing inverse fast Fourier transform on said output frequency spectrum to form an output signal; and
an overlap-and-add unit for overlapping and adding said output signal to form a final output signal;
wherein said perceptual sparse processing unit removes high frequency components from said segmented input frequency spectrum based on a threshold.

32. An apparatus for efficient convolution, comprising:
an overlapping and segmenting unit for overlapping and segmenting an input signal into overlapped-and-segmented input signals;
a FFT processor for performing fast Fourier transform on each overlapped-and-segmented input signal to a segmented input frequency spectrum;
a perceptual sparse processing unit for removing high frequency components from said segmented input frequency spectrum to form a segmented perceptual input frequency spectrum;
a plurality of memory devices for storing a plurality of segmented response frequency spectra;
a plurality of buffers for buffering a plurality of said segmented perceputal input frequency spectra;
a plurality of multipliers for multiplying said buffered plurality of segmented perceputal input frequency spectra with said plurality of segmented response frequency spectra to form a plurality of segmented output frequency spectra;
a summation unit for adding said plurality of segmented output frequency spectra to form an output frequency spectrum;
an IFFT processor for performing inverse fast Fourier transform on said output frequency spectrum to form an output signal; and
a discarding unit for discarding a number of samples from said output signal to form a final output signal;
wherein said perceptual sparse processing unit removes high frequency components from said segmented input frequency spectrum based on a threshold.
